(19) United States
(12) Patent Application Publication
(10) Pub. No.: US 2016/0171178 A1
(43) Pub. Date: Jun. 16, 2016

(54) METHOD AND A SYSTEM FOR GENERATING CLINICAL FINDINGS FUSION REPORT

(71) Applicant: Siemens Aktiengesellschaft, Munich (DE)

(72) Inventor: Chandrashekara RANGAPURA SHETTAPPA, Bengaluru (IN)

(21) Appl. No.: 14/568,179

(22) Filed: Dec. 12, 2014

(51) Int. Cl. G06F 19/00

(52) U.S. Cl. CPC G06F 19/3487; G06F 19/321; G06F 19/3425; G06F 19/3443

(57) ABSTRACT

A method for generation of clinical findings fusion report is presented. The method includes extracting clinical findings in two or more imaging modalities from two or more imaging modality devices. The method further includes processing the clinical findings to identify a data format of the imaging modality and harmonizing the clinical findings from two or more imaging modality devices. The method next involves comparing the clinical findings from two or more imaging modality devices and finding differences. Finally, the method includes generating a clinical findings fusion report highlighting the differences. Also presented is a system in accordance with aspects of an embodiment of the present invention.

### FIELD

At least one embodiment of the present invention relates to a method for generating clinical findings fusion report and more particularly generation of clinical findings fusion report from clinical findings extracted from two or more imaging modality devices where the clinical findings are in multiple imaging modalities.

### BACKGROUND

Imaging devices in medical fields are used to capture medical images and physicians or medical analysts arrive at the clinical findings based on their observations of such medical images. Each imaging device records clinical findings in a certain imaging modality, such as CT, MRI, SPECT etc. The physician then diagnoses the medical condition based on such clinical findings.

In the current state of medical diagnoses, referral sources like consultant pathologist, radiologist, or other digital analysts may feel uncomfortable rendering a final diagnosis on a difficult case and/or a case outside his or her area of expertise, based on a single set of clinical findings. Such referral sources like consultant pathologist, radiologist, or other digital analysts may want a second opinion before making a final decision about the diagnosis that they provide. Or he would prefer comparing clinical findings with another medical practitioner before rendering a diagnosis. Alternatively, a patient may simply ask for a second opinion on the clinical findings.

The currently available clinical diagnosis systems and methods provide individual reports of clinical findings from a single imaging modality device in its corresponding imaging modalities. In order to provide a second opinion based on clinical findings the physician makes use of another imaging modality device or source and makes an observation of the clinical findings. Now, based on the two sets of clinical findings in two clinical modalities the physician feels more comfortable to make the diagnosis which is more reliable than the diagnoses made based on single set of clinical findings.

But the problem in the above method is that the physician takes more time to arrive at the second opinion as he has to analyze clinical findings in two imaging modalities separately. The physician can manually compare these individual reports coming from different sources to arrive at his diagnosis. But the complexity of these medical reports makes the procedure time consuming and the comparison of results from numerous medical reports is a cumbersome task and is prone to errors.

Also since there are more than one set of imaging modalities the format of the clinical findings may also be different. Therefore, comparing the multiple sets of clinical findings in multiple imaging modalities extracted from multiple imaging modality devices involves a time consuming and a highly complex process. There is no system and method for fusing clinical findings of different medical modalities, such as CT, MRI and SPECT, from different sources.

Prior art U.S. Patent Application No. US 2010/0099974 A1 is of interest with respect to this patent application. In this invention a system processes medical report data associated with different types of imaging modality devices to provide a composite examination report. An acquisition processor in the system acquires multi-modality medical imaging examination report data for examinations performed on a patient by different types of imaging modality device. A report processor processes acquired multi-modality medical imaging examination report data items by, in response to predetermined selection riles, selecting between individual data items in the acquired multi-modality medical imaging examination report data items to provide a single individual data item for incorporation in a composite report.

The report processor maps individual data items including the single individual data item in the acquired multi-modality medical imaging examination report data items to corresponding data fields in a composite report data structure in memory in response to predetermined mapping information. An output processor outputs data representing the composite report to a destination device.

### SUMMARY

At least one embodiment of the above invention is directed to generating a composite examination report. It targets multi-modality medical imaging devices, wherein the outputs of multi-modality medical devices are used as inputs for the system.

However, in the above embodiment of the invention there is no comparison report available to the physician from which the physician can view clinical findings from different sources in a format that can be directly compared. It also does not provide any means for recording and identifying the clinical findings that are most accurate and differentiating them from the clinical findings that may be erroneous.

In an embodiment of the above invention, the physician is presented with the final composite report with one set of clinical findings. But there is a problem that is not addressed in the above embodiment of the invention. If the physician wants to analyze the clinical findings in a comparative mode and select the findings more suitable and accurate according to his experienced judgment to make the most correct diagnosis he does not get that opportunity.

There is also no option for exchange of information between physicians, radiologists etc. or the option of providing a second opinion based on multiple sets of clinical findings. Moreover, there is no feature to highlight the difference in clinical findings acquired from different sources or medical imaging modality devices.

Therefore, there exists a need for a method of fusing clinical findings data which gives the physician the flexibility to give a second opinion based on clinical findings from multiple imagining modalities acquired by multiple imaging modality devices so that the physician has the freedom to choose the most appropriate clinical findings and also determine which of the imaging modalities from the different sources is best suited for diagnosis of a particular medical condition.

An embodiment of the present invention provides a simple method for generating a clinical findings fusion report in multiple imaging modalities, extracted from both single and multiple modality imaging devices, which gives the physician an option to provide a diagnosis based on a second opinion from the clinical findings fusion report generated. An embodiment of the present invention provides for a system that allows the physicians to exchange medical reports, especially for special medical cases.

A method for generating a clinical findings fusion report is disclosed. The method and system according to the principles of at least one embodiment of the present invention address the aforementioned deficiencies and related problems.

A method for generating a clinical findings fusion report is presented. The method comprises a first step of extracting clinical findings in two or more imaging modalities from two or more imaging modality devices. The second step comprises of processing the clinical findings to identify a data format of the imaging modality. The next step is harmonizing the clinical findings from two or more imaging modality devices. The next step involves comparing the clinical findings from two or more imaging modality devices and finding differences. The final step constitutes generation of a clinical findings fusion report highlighting the differences.

In an embodiment of the system for generating a clinical findings fusion report, the system comprises a clinical findings extractor, a clinical findings processor, a harmonizing unit, a comparator unit and a display unit. The clinical findings extractor extracts clinical findings in two or more imaging modalities from two or more imaging modality devices. The clinical findings processor processes the clinical findings to identify a data format of the imaging modality. The harmonizing unit harmonizes the clinical findings from two or more imaging modality devices. The comparator unit compares the clinical findings from two or more imaging modality devices and finds differences. The display unit displays the clinical findings fusion report highlighting the differences.

### BRIEF DESCRIPTION OF THE DRAWINGS

The present technique is further described hereinafter with reference to illustrated embodiments shown in the accompanying drawings, in which:

FIG. 1 schematically represents an example embodiment of a system for generating a clinical findings fusion report;

FIG. 2 schematically represents an example clinical findings fusion report having multiple imaging modalities;

FIG. 3 schematically represents an example clinical findings table showing multiple measurements in multiple imaging modalities;

FIG. 4 schematically represents an example clinical finding comprising a corresponding DICOM code and a mapping file with three sections;

FIG. 5 schematically represents an embodiment of the present method for generating a clinical findings fusion report; in accordance with aspects of the present technique.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A method for generating a clinical findings fusion report is presented. The method comprises a first step of extracting clinical findings in two or more imaging modalities from two or more imaging modality devices. The second step comprises of processing the clinical findings to identify a data format of the imaging modality. The next step is harmonizing the clinical findings from two or more imaging modality devices. The next step involves comparing the clinical findings from two or more imaging modality devices and finding differences. The final step constitutes generation of a clinical findings fusion report highlighting the differences.

The present technique has several advantages over the conventional clinical findings report generation methods. A consolidated fusion report of clinical finds of multiple imaging modalities from multiple sources will help the consultant pathologist, radiologist, or any other digital analyst for providing a final diagnosis on a difficult medical case with more surety. It also helps a patient to obtain a second opinion on the clinical findings and compare the results of clinical findings from different sources.

The present method provides a comparison of findings based on different types of images such as CT, MRI and SPECT and second opinion results. It would also help a physician or a medical diagnostic practitioner to exchange information on special cases. Also, if the physician observes a large difference in findings obtained from one source in comparison with the other sources or imaging modality devices then there is an ease of detection of erroneous readings or faulty devices.

In an embodiment of the present invention, the data format comprises at least one of a DICOM SR compatible data format, an XML data format, an HL7 data format and a proprietary data format. Any other data format commonly used in the field of medical imaging and diagnostics can also be used. This ensures that the clinical findings in different data formats are compatible with the disclosed system and method and the physician has the option to use clinical findings from a variety of imaging modality devices.

In another embodiment, the step of harmonizing the clinical findings from two or more imaging modality devices further comprises a step of comparing the data format of the imaging modality with a common data format. If the data format of the imaging modality is different from the common data format then the step further comprises converting the data format of the imaging modality to the common data format so that the clinical findings are harmonized. The harmonization of the clinical findings to a common data format ensures an easy comparison between clinical findings of different imaging modalities from different imaging modality devices.

In another embodiment of the method, each clinical finding is associated with a corresponding DICOM code and a mapping file for matching the clinical findings in two or more imaging modalities from two or more imaging modality devices. The mapping file comprises of a value mapping section, a supported template section and a mapping entry. The mapping file contains information about the measurements, calculations, etc. taken from different imaging modality devices. In a further embodiment the mapping files are created for different imaging modalities based on the organ, for example, left ventricle. Mapping files are created to match the clinical findings received in different imaging modalities from different imaging modality devices.

The value mapping section is for mapping units of the measurements of clinical findings with DICOM SR code names. Supported template section contains templates for preparation of medical reports for particular medical conditions, for example, adult echocardiography procedure report. A sample mapping entry would contain aortic valve (AoV) area planim calculation result mapped with cardiovascular orifice area with image mode as 2D.

In another embodiment, the method further comprises a step of checking if the DICOM code associated with each clinical finding is already present in a dictionary library. If the DICOM code is not present in the dictionary library the DICOM code is added to the dictionary library and a corresponding mapping entry is created in the mapping file. The dictionary library ensures that a database is maintained from where relevant clinical findings can be fetched when necessary in the future. For example, if a doctor has to prepare a medical report for a medical condition containing clinical findings collected over a period of time for numerous patients.

In one embodiment of the method, the imaging modality device comprises one of an MR imaging device, a CT scan imaging device, an MRI imaging device, an X-ray imaging device, an Ultra-sound imaging device, a nuclear PET scanning imaging device and a SPECT imaging device. The method can also include any other imaging modality device commonly used in the medical field. The variety in imaging modality devices ensures that the method works for numerous types of imaging modalities.

In an embodiment of the system for generating a clinical findings fusion report, the system comprises a clinical findings extractor, a clinical findings processor, a harmonizing unit, a comparator unit and a display unit. The clinical findings extractor extracts clinical findings in two or more imaging modalities from two or more imaging modality devices. The clinical findings processor processes the clinical findings to identify a data format of the imaging modality. The harmonizing unit harmonizes the clinical findings from two or more imaging modality devices. The comparator unit compares the clinical findings from two or more imaging modality devices and finds differences. The display unit displays the clinical findings fusion report highlighting the differences.

In another embodiment of the system, the system further comprises a database unit containing a dictionary library wherein the dictionary library comprises DICOM codes and mapping files associated with the clinical findings. The database unit provides a ready stock of clinical findings collected over time ready for use in any special situation that requires using old clinical findings to prepare a medical report. Saving of DICOM codes and mapping files in the database unit helps in storing of new and unique formats that the system comes for the first time. So, when the next time the system encounters a format for a clinical findings already stored in the database unit, the system saves time.

Using the present system it is also possible to arrive at an imaging modality which is most reliable for detecting certain medical conditions or clinical findings. In other words, the present system and method also enables one to decide upon the appropriateness of an imaging technique and analyze how these results compare to corresponding findings of other modalities acquired from other imaging modality devices.

The best modality to reliably detect a clinical finding is determined by the success rate calculation. The clinical finding technique with different modality differs from geographical region to region. The value that is considered as normal in one geographical region might be considered as abnormal in another geographical region. Other factors considered are the age, health condition, different long-term and short term disease etc. For example, the criteria for finding clinical findings from cardiac CT scan differ from Europe region when compared to Asia region.

These data and techniques used for finding clinical findings are entered in to the database unit which can be data mined based on the success rate of each modality to identify the clinical findings. Using this data mining step the reliable modality to find the clinical findings can be determined.

Different modalities use different formula and technique to identify the clinical findings thus the results will be different. Different units, formula etc. are used for calculation. Normal and abnormal value ranges are displayed along with the findings from different modalities. For example, mass measured in terms of pounds and kilograms, different formula used for BSA calculation etc. By using the range of normal and abnormal values used in different modalities a universal clinical findings comparison can be determined.

Hereinafter, above-mentioned and other features of the present technique are described in details. Various embodiments are described with reference to the drawings, wherein like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the invention. It may be evident that such embodiments may be practiced without these specific details.

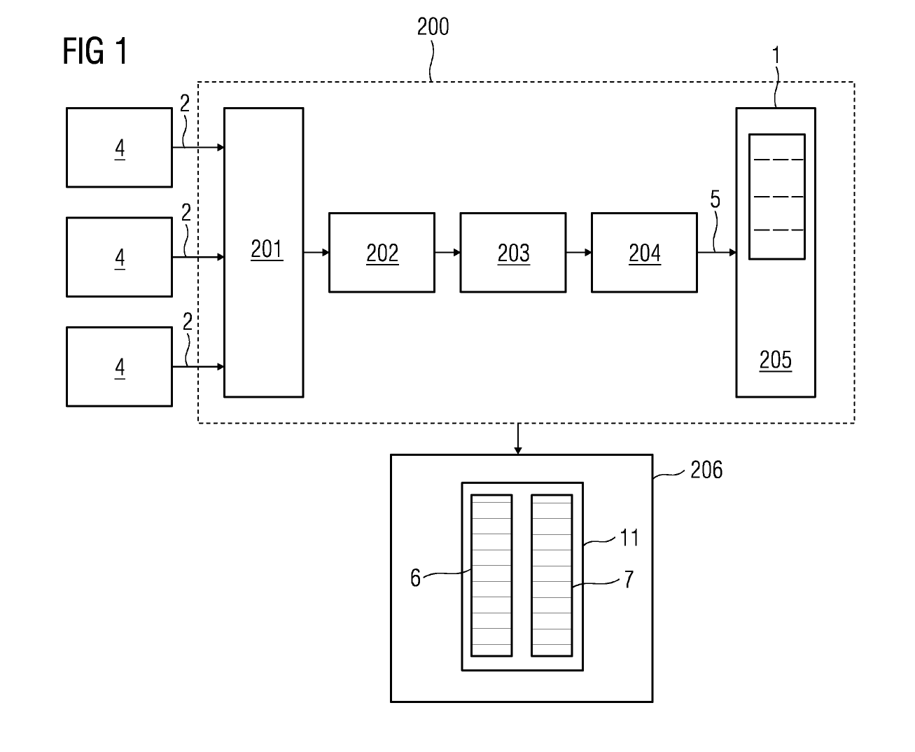

FIG. 1 shows a schematic diagram of an example embodiment of the system 200 for generating a clinical findings fusion report 1. The system includes a clinical findings extractor 201, a clinical findings processor 202, a harmonizing unit 203, a comparator unit 204 and a display unit 205.

Clinical findings 2 in various imaging modalities are acquired by the multiple imaging modality devices 4. These clinical findings are then extracted by the clinical findings extractor 201. Next, the clinical findings processor 202 processes these clinical findings 2 to identify a data format of for each imaging modality 3 (not shown in FIG. 1). After identification of the data format, the harmonizing unit 203 harmonizes the clinical findings 2 from two or more imaging modality devices 4. The harmonizing step comprises of comparing the data format of the imaging modality 3 with a common data format. If the data format of the imaging modality 3 is different from the common data format then the step further comprises converting the data format of the imaging modality 3 to the common data format so that the clinical findings 2 are harmonized.

The comparator unit 204 then compares the clinical findings 2 from two or more imaging modality devices 4 and finds differences 5. These differences basically present to the physician the measurements taken from various imaging modality devices 4 that may vary from each other. The display unit 205 displays the clinical findings fusion report 1 highlighting these differences 5. The physician is thus supplied with a clinical findings fusion report 1 complete with the clinical findings 2 information captured from single or multi-modality imaging devices 4 highlighting the difference 5 in measurements. In one embodiment the differences 5 may be presented in the form of superimposing of the clinical findings 2 from one imaging modality device 4 with that of another device 4. In another embodiment the differences 5 are represented in the form of a comparison report.

In an example situation, the clinical findings are related to the head circumference of a foetus. There are two different imaging modality devices 4, one from a vendor A and another from a vendor B. According to one embodiment the clinical findings 2 are measured in centimeters for both the devices 4. According to another embodiment the device 4 from vendor A measures in millimeters and the device 4 from vendor B measures in centimeters.

The system 200 additionally comprises a database unit 206 containing a dictionary library 11. The dictionary library 11 comprises DICOM codes 6 and mapping files 7 associated with the clinical findings 2. This database unit 206 is an organized storehouse for storing clinical findings 2 data for future reference or use. Each time a new data format associated with the clinical findings 2 is identified an entry is made into the dictionary library 11 of this database unit 206. Every entry shall have a DICOM code 6 and a mapping file 7 associated with it.

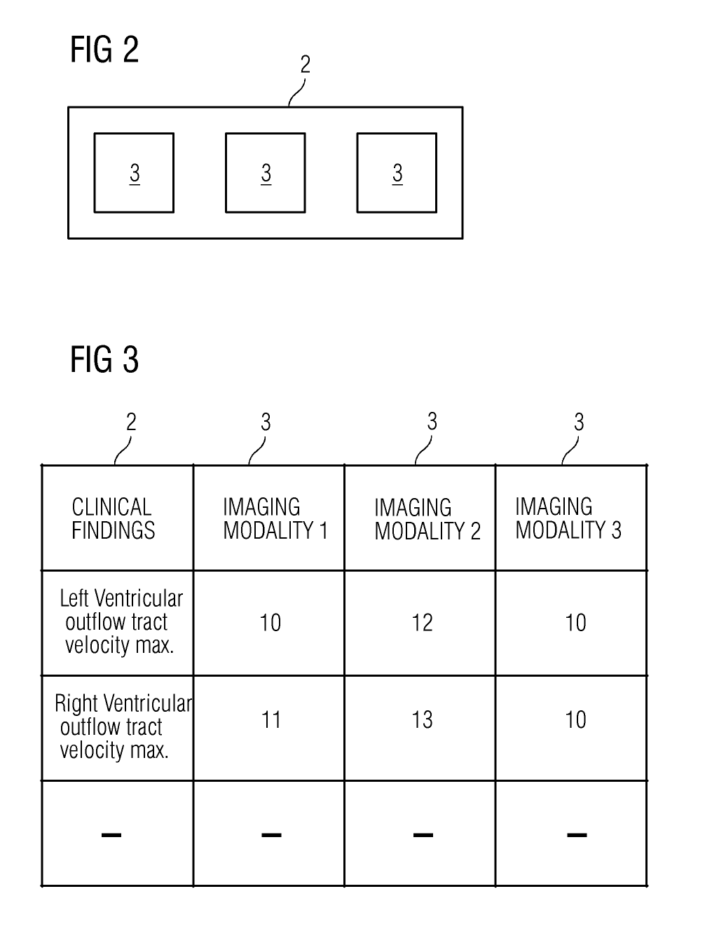

FIG. 2 schematically represents an example clinical findings fusion report 1 having multiple imaging modalities 3. Each of these imaging modalities 3 could be fetched from a variety of imaging modality devices 4. For example, MR imaging device, a CT scan imaging device, an MRI imaging device, an X-ray imaging device, an Ultra-sound imaging device, a nuclear PET scanning imaging device and a SPECT imaging device.

FIG. 3 schematically represents an example clinical findings 2 table showing multiple measurements in multiple imaging modalities 3. The left column of the table shows the clinical findings 2 names. The first row contains measurements of ‘left ventricular outflow tract velocity maximum’. The second row contains measurements of ‘right ventricular outflow tract velocity maximum’. The next three columns contain the recorded measurements from different imaging modality devices 4 in their corresponding imaging modalities 3. As seen from FIG. 3 the values may differ depending on the source or the imaging modality device 4.

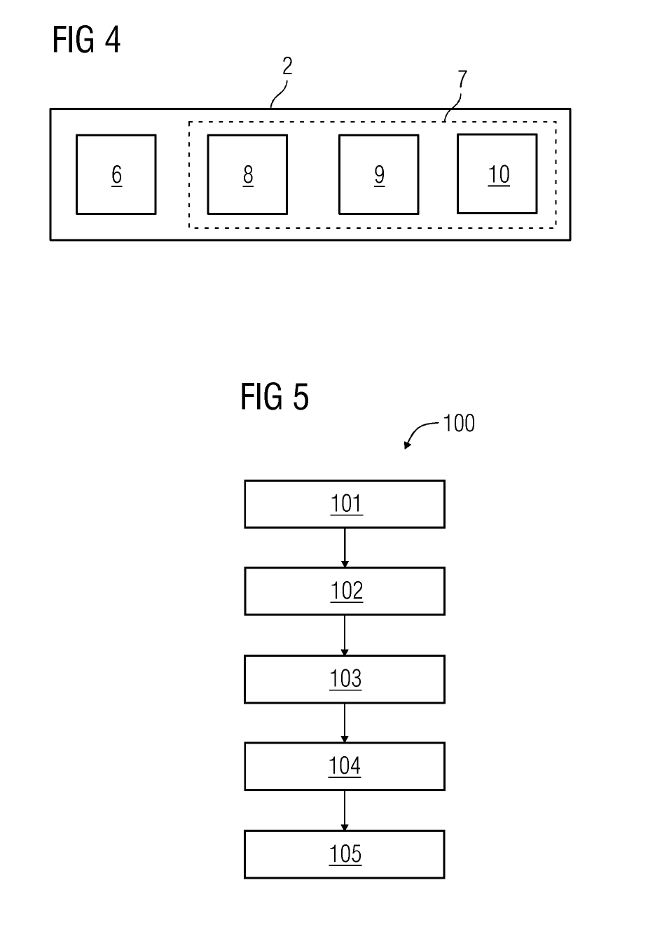

FIG. 4 schematically represents an example clinical finding 2 comprising a corresponding DICOM code 6 and a mapping file 7 with three sections, namely, value mapping section 8, supported template section 9 and mapping entry 10. The value mapping section 8 maps the units of the measurements of clinical findings 2 with DICOM SR code 6 names. Supported template section 9 contains templates for preparation of medical reports for particular medical conditions, for example, adult echocardiography procedure report. A sample mapping entry 10 would contain aortic valve (AoV) area planim calculation result mapped with cardiovascular orifice area with image mode as 2D.

FIG. 5 schematically represents an embodiment of the present method 100 for generating a clinical findings fusion report 1 in accordance with aspects of the present technique. As seen in FIG. 5 the method 100 comprises of five major steps. The first step 101 is of extracting clinical findings 2 in two or more imaging modalities 3 from two or more imaging modality devices 4. The second step 102 is processing the clinical findings 2 to identify a data format of the imaging modality 3. The third step 103 comprises of harmonizing the clinical findings 2 from two or more imaging modality devices 4. The next step 104 constitutes comparing the clinical findings 2 from two or more imaging modality devices 4 and finding differences 5. The final step 105 comprises generating the clinical findings fusion report 1 highlighting the differences 5.

While the present technique has been described in detail with reference to certain embodiments, it should be appreciated that the present technique is not limited to those precise embodiments. Rather, in view of the present disclosure which describes example modes for practicing the invention, many modifications and variations would present themselves, to those skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for generating a clinical findings fusion report, the method comprising:
extracting clinical findings in two or more imaging modalities from two or more imaging modality devices;
processing the clinical findings to identify a data format of the imaging modality;
harmonizing the clinical findings from two or more imaging modality devices;
comparing the clinical findings from two or more imaging modality devices and finding differences; and
generating the clinical findings fusion report highlighting the differences.

2. The method of claim 1, wherein the data format comprises at least one of a DICOM SR compatible data format, an XML data format, an HL7 data format and a proprietary data format.

3. The method of claim 1, wherein the harmonizing of the clinical findings from two or more imaging modality devices further comprises comparing the data format of the imaging modality with a common data format and converting the data format of the imaging modality to the common data format if the data format of the imaging modality is different from the common data format, so that the clinical findings are harmonized.

4. The method of claim 1, wherein each clinical finding is associated with a corresponding DICOM code and a mapping file for matching the clinical findings in two or more imaging modalities from two or more imaging modality devices;
and wherein the mapping file comprises of a value mapping section, a supported template section and a mapping entry.

5. The method of claim 1, further comprising:
checking if the DICOM code associated with each clinical finding is present in a dictionary library; and
adding the DICOM code to the dictionary library and creating a corresponding mapping entry in the mapping file if the DICOM code is not present in the dictionary library.

6. The method of claim 1, wherein the imaging modality device comprises one of an MR imaging device, a CT scan imaging device, an MRI imaging device, an X-ray imaging device, an Ultra-sound imaging device, a nuclear PET scanning imaging device and a SPECT imaging device.

7. A system for generating a clinical findings fusion report, the system comprising:
a clinical findings extractor to extract clinical findings in two or more imaging modalities from two or more imaging modality devices;
a clinical findings processor to process the clinical findings to identify a data format of the imaging modality;
a harmonizing unit to harmonize the clinical findings from two or more imaging modality devices;
a comparator unit to compare the clinical findings from two or more imaging modality devices and finding differences; and
a display unit to display the clinical findings fusion report highlighting the differences.

8. The system of claim 7, further comprising:
a database unit, containing a dictionary library, wherein the dictionary library comprises DICOM codes and mapping files associated with the clinical findings.

9. The method of claim 2, wherein the harmonizing of the clinical findings from two or more imaging modality devices further comprises comparing the data format of the imaging modality with a common data format and converting the data format of the imaging modality to the common data format if the data format of the imaging modality is different from the common data format, so that the clinical findings are harmonized.

10. The method of claim 2, wherein each clinical finding is associated with a corresponding DICOM code and a mapping file for matching the clinical findings in two or more imaging modalities from two or more imaging modality devices;
and wherein the mapping file comprises of a value mapping section, a supported template section and a mapping entry.

11. The method of claim 2, further comprising:
checking if the DICOM code associated with each clinical finding is present in a dictionary library; and
adding the DICOM code to the dictionary library and creating a corresponding mapping entry in the mapping file if the DICOM code is not present in the dictionary library.

12. The method of claim 2, wherein the imaging modality device comprises one of an MR imaging device, a CT scan imaging device, an MRI imaging device, an X-ray imaging device, an Ultra-sound imaging device, a nuclear PET scanning imaging device and a SPECT imaging device.
